(19) United States
(12) Patent Application Publication
(10) Pub. No.: US 2023/0351504 A1
(43) Pub. Date: Nov. 2, 2023

(54) SYSTEM AND METHOD FOR PUSHING RECOMMENDED FINANCIAL TRANSACTIONS TO A CLIENT DEVICE

(71) Applicant: Stirlingshire Investments, Inc., New York, NY (US)

(72) Inventor: Steven Woods, New York, NY (US)

(73) Assignee: Stirlingshire Investments, Inc., New York, NY (US)

(21) Appl. No.: 18/197,675

(22) Filed: May 15, 2023

Related U.S. Application Data
(63) Continuation-in-part of application No. 17/141,160, filed on Jan. 4, 2021.

(51) Int. Cl. G06Q 40/04

(52) U.S. Cl. CPC G06Q 40/04; G06Q 2220/10

(57) ABSTRACT

This disclosure describes, in part, systems and techniques for pushing trade recommendations to a client device. A broker device may execute an instance of a broker application that receives input associated with a trade order recommendation and may generate a trade order using the input. The broker application may transmit the trade order and supporting due diligence data to the client device. The client device may receive the client's response on whether to execute the trade (approval) or not (rejection) and may transmit the client's determination to the broker application. The broker application may store the client's response and may restrict modification thereto. If the client response includes an approval, the broker application may transmit the associated trade order to an execution venue. If the client includes a rejection, the broker application may transmit the rejected trade order recommendation to a rejected queue.

### TECHNICAL FIELD

### Cross-Reference to Related Applications

This application is a continuation of U.S. patent application Ser. No. 17/141,160, filed Jan. 4, 2021. The application is hereby incorporated herein by reference.

### BACKGROUND

Traditionally, a broker or financial advisor who works in a full-service capacity, one who makes recommendations as to what assets a customer should buy or sell, will speak with a client over the phone to discuss what buys and sells he/she recommends. Upon verbal agreement, the advisor enters and executes the order that s/he agreed or believes s/he agreed with the customer. This sequence of events can cause several problems, the first is simply unauthorized trading. Unauthorized trading is where a broker or advisor who does not have authorization for trading discretion does not actually speak with a client before executing a trade in the client's account. This type of trading happens far more frequently than many like to admit and can be very detrimental to the client. Often this is done by an advisor simply to charge a commission.

Additionally, brokers or financial advisors owe a duty to the client to provide a sound basis for any recommendations. These same brokers and financial advisors may be challenged by clients, brokerages, and government regulators to justify any due diligence performed before any recommendation is made. These challenges typically arise when a recommendation does not provide the financial results that are expected. Documenting what information is used as a basis for the recommendation and that the information was, in fact, provided to a client before a trade is made can be difficult to produce well after the trade has occurred.

Therefore, a need exists for a solution pushing recommended trades to a client device in a manner that virtually eliminates unauthorized trading. The instant disclosure seeks to address the limitations and deficiencies in existing solutions according to the principles and example embodiments disclosed herein.

### BRIEF DESCRIPTION OF THE DRAWINGS

Referring now to the drawings in which like reference numbers represent corresponding parts throughout:

FIG. 1 is a block diagram illustrating a recommended trade pushing environment, in accordance with some embodiments.

FIG. 2 depicts a non-limiting flow diagram illustrating an example method for pushing trade recommendations to a client device, according to certain embodiments, in accordance with certain embodiments.

FIG. 3 illustrates an example order user interface (UI) that includes the order, in accordance with yet still other embodiments.

FIG. 4 depicts a non-limiting flow diagram illustrating an example method for pushing trade recommendations to a client device, in accordance with some embodiments.

FIG. 5 depicts a non-limiting flow diagram illustrating an example method for pushing trade recommendations to a client device, in accordance with other embodiments.

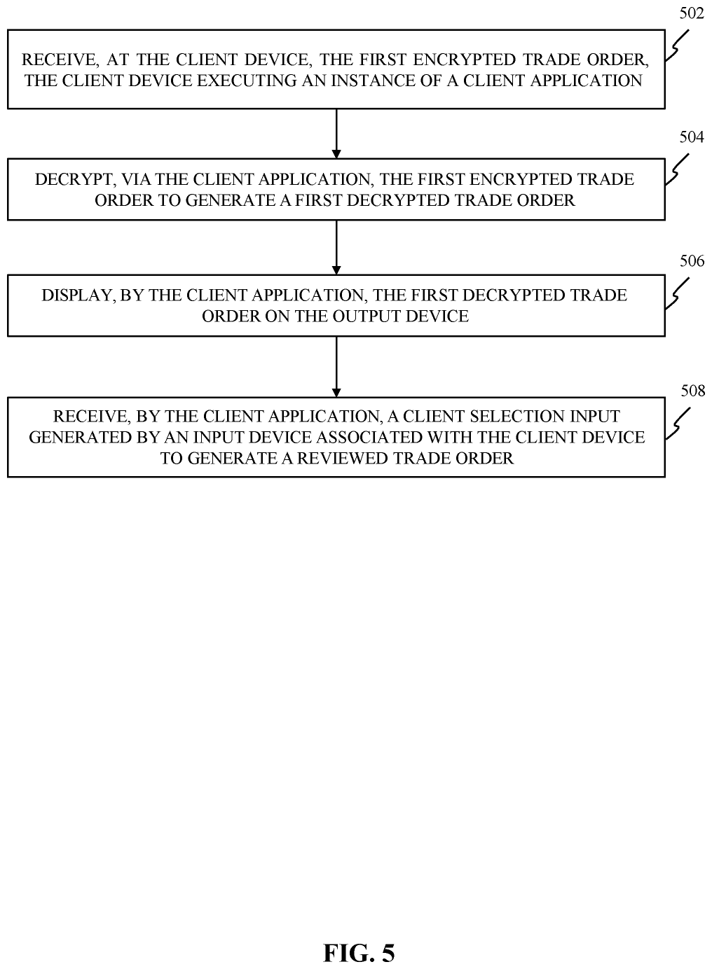

FIG. 6 depicts a non-limiting flow diagram illustrating an example method for pushing trade recommendations to a client device, in accordance with certain embodiments.

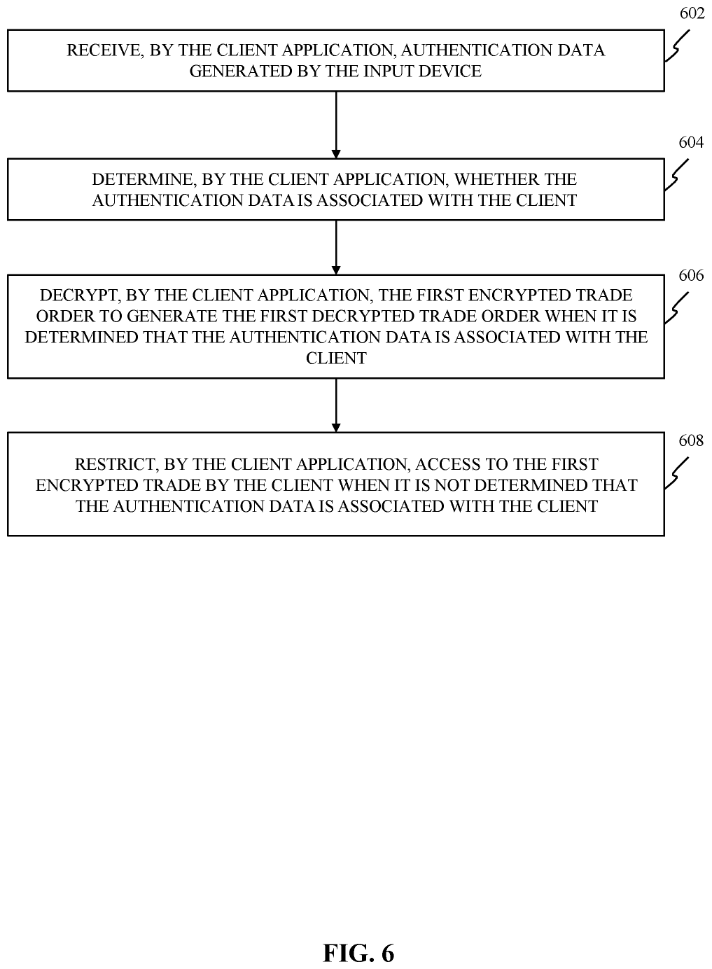

FIG. 7 depicts a block diagram of components of a computing device, in accordance with yet still other embodiments.

### DETAILED DESCRIPTION

The instant disclosure relates in general to a system and method for providing financial services, and more specifically, to a system and method for providing trustless trade recommendations to clients.

A broker is an individual or firm that acts as an intermediary between an investor and a securities exchange or other trading system. The term “security” refers to a fungible, negotiable financial instrument that holds some type of monetary value. A security can represent ownership in a corporation in the form of stock, a creditor relationship with a governmental body or a corporation represented by owning that entity's bond; or rights to ownership as represented by an option. Publicly traded securities are listed on stock exchanges, where issuers can seek security listings and attract investors by ensuring a liquid and regulated market in which to trade. Informal electronic trading systems may also be used, and securities can be traded “over the counter,” or directly among investors either online or over the phone.

Traditionally, when a broker or financial advisor desires to suggest a trade opportunity to clients, they speak directly with the client over the phone to discuss what buys and sells the advisor recommends. The client then agrees, or disagrees, and the broker acts on the client's behalf, having full access to execute trades on behalf of the client. This sequence of events can cause several problems, which include, but is not limited to, erroneous quantities, erroneous instruments, and worst of all unauthorized trading. The problem of unauthorized trades occurs when brokers execute transactions on behalf of their clients without obtaining proper authorization or approval. This can happen due to various reasons such as miscommunication, negligence, or even intentional misconduct. Unauthorized trades can lead to significant financial losses for clients, disrupt their investment strategies, and erode trust in the broker-client relationship. It is crucial for brokers to adhere to strict protocols and obtain explicit consent from clients before executing any trades to ensure transparency, accountability, and protect the client's best interests.

Furthermore, unauthorized trading is not compliant with the broker's fiduciary duty that they owe to their client. A fiduciary duty is a legal and ethical obligation that a broker has to act in the best interests of their clients. It encompasses a duty of loyalty, care, and utmost good faith. This duty requires the broker to prioritize the client's interests above their own, avoid conflicts of interest, provide accurate and transparent information, and exercise diligence and skill in managing the client's investments. The fiduciary duty establishes a relationship of trust and confidence, ensuring that the broker acts in a responsible and professional manner to safeguard the client's financial well-being. The instant disclosure seeks to provide a solution for pushing recommended trades to clients that does not require the client to trust that their broker adheres to the client's wishes concerning the recommended trade. Hence, the instant disclosure seeks to provide a solution to help brokers reinforce the fiduciary duty owed to the client.

The disclosure describes, in part, systems and techniques for pushing “trustless” trade recommendations (e.g., to purchase securities) to clients. Trustless trade recommendations require client approval to be eligible for direct execution. In other words, if the client does not approve a recommendation, the trade will not be routed to the trading venue. The client is absolutely certain that their broker cannot execute the trade without their authorization when “trustless” trade recommendations are used.

In a non-limiting example, a broker desires to recommend a trade for a security to one of their clients using an application on their computing device. To initiate the process, the broker uploads the security name, number of shares to purchase, purchase price range, and financial due diligence documents that they reviewed for the recommendation (e.g., earnings reports, assets lists, associated liabilities, current/projected cashflow, associated debt obligations, broker analysis data, management biographies, commercial documentation, and/or other financial documentation) to the application. The application stores the financial due diligence documents, generates uniform resource locators (URL) for the documents, and adds the URLs to the recommended trade order.

The application pushes the order (i.e., the recommended trade) and associated URLs to the client's device for review by the client. The client device displays the recommended trade as an interactive GUI that includes an option to confirm the trade or deny the trade. In response to the client selecting one of the options, the application causes the client device to transmit the client response, as entered by the broker, to the broker device for transmission to an execution venue (i.e., an entity with which client orders are placed and/or to which the), if accepted, or to a rejected queue if rejected. Rejected trade orders that are sent to the rejected queue are not eligible for execution. The application stores a copy (e.g., locally or remotely) of the client response. If the client's response confirms the trade, the application forwards the order for execution (e.g., number of shares, desired price range, limits). However, if the client's response denies the trade, the application rejects the trade.

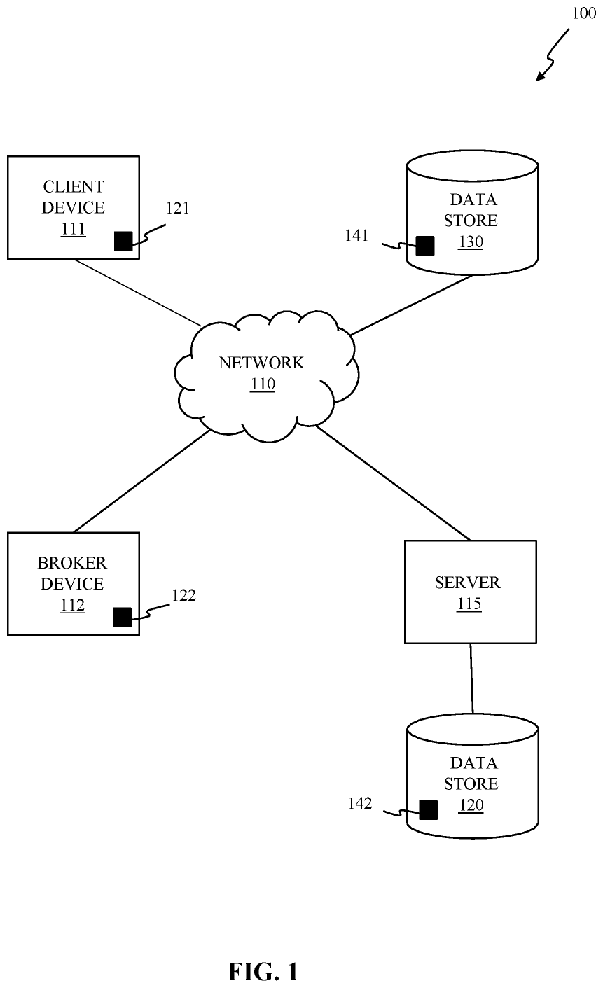

FIG. 1 is a block diagram illustrating a recommended trade pushing environment, generally 100, according to some embodiments. The environment 100 includes a broker device 112, a client device 111, a server 115, and a data store 130 interconnected via a network 110. The broker device 112 refers to computing devices associated with the financial firm that generates the trade recommendation for the client. The network 110 can be, for example, a local area network (LAN), a wide area network (WAN) such as the Internet, or a combination of the two, and can include wired, wireless, or fiber optic connections. In general, the network 110 can be any combination of connections and protocols that will support communications between the broker device 112, the client device 111, the server 115, and the data store 130.

In various embodiments, the broker device 112, the client device 111, and the server 115 may be a laptop computer, a tablet computer, a mobile computing device, a wearable computing device, netbook computer, a computer cluster, a distributed computing system, a personal computer (PC), a desktop computer, a personal digital assistant (PDA), a smart phone, or any programmable electronic device capable of communicating with the broker device 112, the client device 111, and/or the server 115 via the network 110. The server 115 may act as a simple relay device to forward orders on to the client's device 111. The server 115 also may store orders on a data 120 (e.g., in files 120) for later retrieval. The data store 120 is a repository that stores and manages collections of data which include not just repositories like databases, but also simpler store types such as simple files, emails, etc. The data store 120 may be a distributed data store. The data store 120 can be a plurality of data stores that work together. The data store 120 can store information in a self-referential database for faster retrieval. The server 115 also may be used to retain copies of orders and associated client responses for later use in documenting the transaction. In some embodiments, the server 115 executes the application. The server 115 may store a copy of the application for access via the client device 111 and/or the broker device 112.

The broker device 112 and/or the client device 111 may include a control circuit(s) that work together to perform one or more steps, processes, and/or functions disclosed in the instant application. The control circuit can be any control circuit known in the art capable of performing one or more steps, processes, and/or functions disclosed in the instant application (e.g., microcontrollers, microprocessors, embedded processors, digital signal processors, media processors, application-specific processors, application-specific instruction set processors, ASIC processors, etc.).

The data store 130 is a repository that stores and manages collections of data which include not just repositories like databases, but also simpler store types such as simple files, emails, etc. For example, the data store 130 can include public and/or private information associated with companies, securities, news, market analysis, historic financial market data, commercial data, weather data, political data, real-time financial market data, etc. In certain embodiments, the data store 130 can be a distributed data store. The data store 130 can be a plurality of data stores each associated with a particular company (e.g., Acme Corp.) or entity (e.g., Acme Financial News Corp., a government database, etc.).

In certain embodiments, a copy of the application resides on the client device 111 (e.g., an application 121) and the broker device 112 (e.g., an application 122). In other embodiments, the application is stored on the data store 120 and the client device 111 and/or the broker device 112 access the application via the server 115 (e.g., via a web browser). The application 121 and the application 122 may access data stored in the data store 120 (e.g., the files 142). The client device 111 and/or the broker device 112 may download a copy of the application from the files 142.

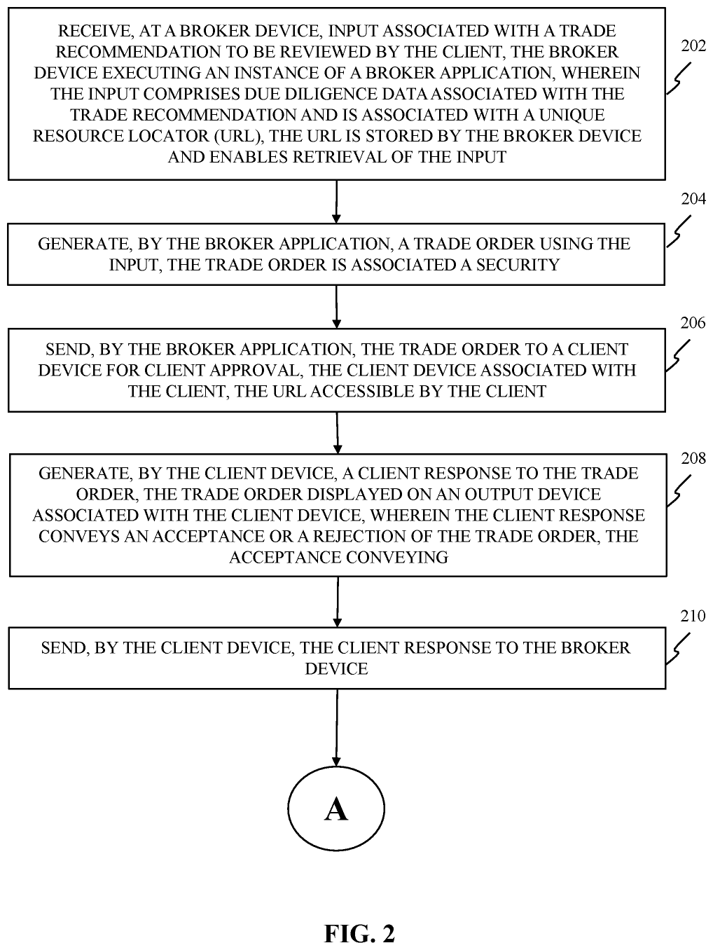

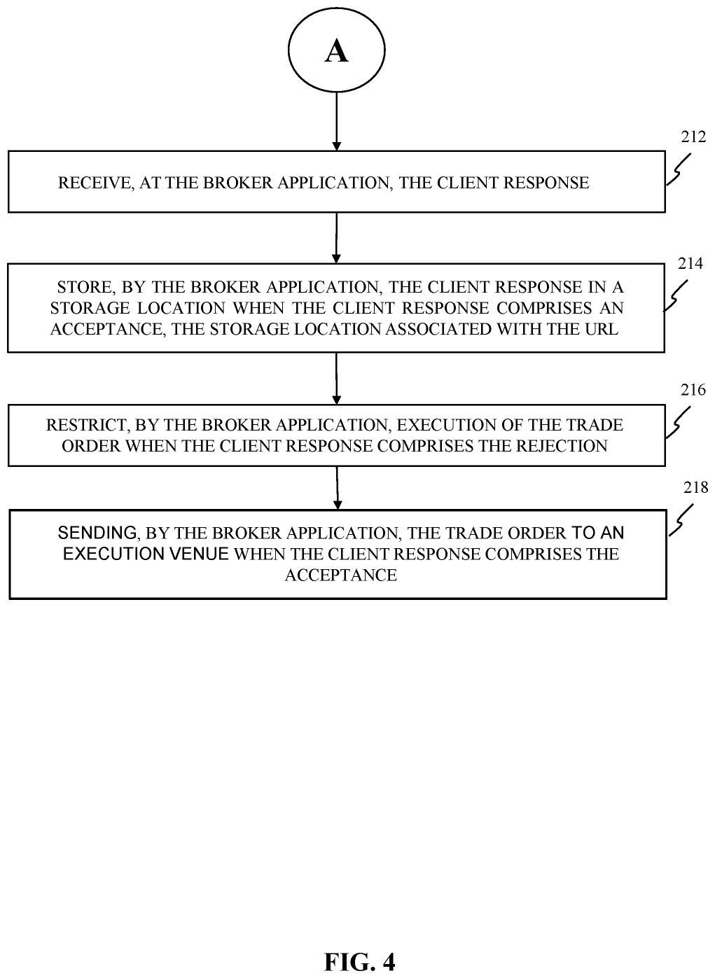

FIGS. 2 and 4 depict a non-limiting flow diagram illustrating an example method, generally 200, for pushing trade recommendations to a client device, according to certain embodiments. In some examples, the method 200 may include one or multiple features, components, and/or functionality of implementations described herein with reference to FIGS. 1, 3 and 7. The method 200 and other methods described herein are illustrated as collections of blocks in logical flow diagrams, which represent a sequence of operations, some or all of which can be implemented in hardware, software, or a combination thereof. In the context of software, the blocks may represent computer-executable instructions stored on one or more computer-readable media that, when executed by one or more processors, program the processors to perform operations. Generally, computer-executable instructions include routines, programs, objects, components, data structures, and the like, that perform particular functions or implement particular data types. The order in which the blocks are described should not be construed as a limitation. Any number of the described blocks can be combined in any order and/or in parallel to implement the method, or alternative methods, and not all of the blocks need to be executed. For discussion purposes, the methods are described with reference to the environments, architectures, and systems described in the examples herein, although the methods may be implemented in a wide variety of other environments, architecture, and systems.

At 202, the method 200 may include receiving, at the broker device 112, input associated with a trade recommendation to be reviewed by the client. For example, the input is received by the application 122. The input may include text, one or more images, a research analysis in support of the trade order (e.g., the research analysis may be associated with a broker and the broker may be associated with the broker device 112), a total number of shares allowed for the trade order, a price limit reflecting the maximum purchase price allowed for each share, and/or a transaction time period reflecting a time frame that the trade order is executable within. The broker device 112 may execute an instance of a broker application (e.g., the application 122), wherein the input may include due diligence data associated with the trade recommendation and a unique resource locator (URL). The URL may point to due diligence data stored in files 141 and/or the files 142. The URL may be stored by the broker device 122 (e.g., locally or remotely) and enable retrieval of the input. At 204, the method 200 may include generating, by the broker application, a trade order using the input. The trade order is associated with a security. At 206, the method 200 may include sending, by the broker application, the trade order to the client device 111 for client approval. The client device is associated with the client. The URL may be accessed by the client (i.e., using the client device 111). At 206, the method 200 may further include encrypting, by the broker application, the trade order to form a first encrypted trade order and sending, by the broker application, the encrypted trade order to the client device 111 for client approval.

At 208, the method 200 may include generating, by the client device 111, a client response to the trade order. The trade order may be displayed on an output device (e.g., a display) associated with the client device 111. The client device 111 and/or the broker device 112 may include one or more output devices (e.g., a display, a touch screen, a speaker, a printer, and/or optical mark reader). The client response conveys an acceptance or rejection of the trade order. At 208, the method 200 may further include the steps of method 500. At 502, the method 500 may include receiving, at the client device 111, the first encrypted trade order. Here, the client device 111 may execute an instance of the client application.

At 504, the method 500 may include decrypting, via the client application, the first encrypted trade order to generate a first decrypted trade order. At 504, the method 500 may include the method 600. At 602, the method 600 may include receiving, by the client application, authentication data generated by the input device. The authentication data may include biometric data (e.g., facial scans, fingerprint scans, voice scans), a password(s), and/or one or more authentication factors. At 604, the method 600 may include determining, by the client application, whether the authentication data is associated with the client. For example, the application 121 may compare the received authentication data with authentication data stored on the client device 111, the data store 130, and/or the data store 120. In certain embodiments, the biometric data is captured via a biometric sensor associated with the client device 111, which may store the captured biometric data locally and/or in the files 142.

The authentication step is successful when the received authentication data shares a threshold percentage match (e.g., 95%-100% or other predetermined percentage) with the stored authentication data. At 606, the method 600 may include decrypting, by the client application, the first encrypted trade order to generate the first decrypted trade order when it is determined that the authentication data is associated with the client (i.e., the authentication step was successful). At 608, the method 600 may include restricting, by the client application, client access to the first encrypted trade when it is not determined that the authentication data is associated with the client.

At 506, the method 500 may include displaying, by the client application, the first decrypted trade order on the output device. At 508, the method 500 may include receiving, by the client application, a client selection input generated by an input device associated with the client device to generate a reviewed trade order. The client device 111 and/or the broker device 112 may include one or more input devices (e.g., a mouse, touch screen keyboard, joystick, camera, and/or a biometric sensor).

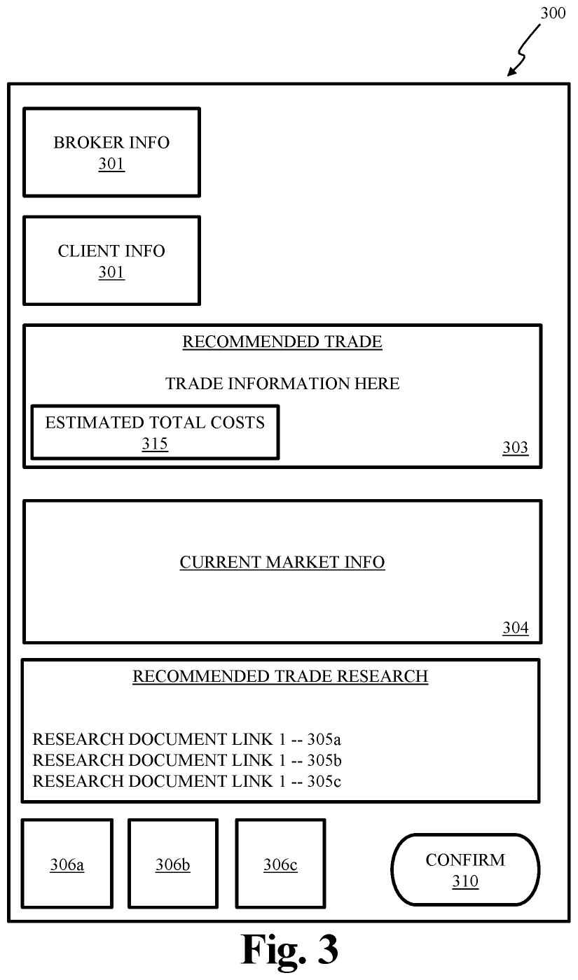

FIG. 3 illustrates an example order user interface (UI), generally 300, that may include the order, according to other embodiments. When an order is received by the client device 111 it may be descripted by the application 121 and conveyed to the client using the order UI 300. The recommended order may include one or more of the following data fields of information: broker info 301, client info 302, recommended trade information 303, current market information 304, recommended trade research URL web links 305a-c (e.g., that point to data stored in the files 141 and/or the files 142), and/or recommended trade research documents 306a-c. The order UI 300 also may include an estimated total cost for the trade 315, a confirm order button 310, and a deny order button 312.

The broker info field 301 may list identifying information regarding the broker that generated and transmitted the order. The client info field 302 may include identifying information regarding the client to which the order was intended. This information may include name, address, phone and mobile numbers, email address and other similar contact information. These phone numbers and email addresses may include a hyperlink that permits the client device 111 to initiate direct communication with the broker device 112.

The recommended trade information 303 may include any and all useful information regarding the proposed trade. This data may include, but is not limited to, order ID, account ID, max and min price for any confirmed trade, an expiration date and time for the order, reference to after-market hours trading and other markets around the world to be used to complete the trade, transaction type, the number of shares, and the expected price.

The current market information 304 may include information on the current state of the market, including various known market indexes, price and index value changes during one or more time periods, and any other information that the broker and client may use to evaluate the recommended trade order. The recommended trade research URL web links 305a-c and recommended trade research documents 306a-c may provide the broker a mechanism to share the due diligence research that is available for consideration by the client. This information may be presented to the client using a URL web link 305a-c that allows the client to review the information available over the network 110 using a web browser. Use of the URL 305 reduces the bandwidth required by the application 122 to transmit the order to the client device 111, which is less than the bandwidth required to transmit the order with the document(s). This information also may be provided in the form of a document 306a-c in which the information is shared along with the order GUI 300. For example, the documents 306a-c may be sent using a standardized file format to present documents that may have text data, image data, and complex formatted documents. The standardized file format may be independent of application software, hardware, and operating systems.

The estimated cost 315 provides the client with an estimate for the cost of the trade as proposed. The estimated cost 315 may include any fees or other expenses to be incurred and may also use current market prices for the security being purchased if current market data is available to the client device 111. When selected, the confirm button 310 may trigger the application 121 to generate a confirmation notification for the order and send it to the broker device to initiate execution of the order. The confirm button 310 may cause the application 121 to generate a message containing the order for the broker to purchase the identified securities, populate the message with data from the order, and/or apply client identification data and/or data encryption to provide an assurance that the authorized client is making the order to purchase the

Returning now to FIG. 2. At 210, the method 200 may include sending, by the client device 111 (i.e., the application 121), the client response to the broker device 112 (i.e., the application 122). At 210, the method 200 may include encrypting, by the client application, the reviewed trade order to generate a second encrypted trade order and sending, by the client application, the second encrypted trade order to the broker application.

At 212, the method 200 may include receiving, at the broker application, the client response. At 214, the method 200 may include storing, by the broker application, the client response in a storage location (e.g., a local data store and/or the files 142 on the data store 120) and restricting modification to the stored client response. In other words, stored client responses are immutable, which supports the broker's fiduciary duty to the client. The storage location may be associated with the URL. At 216, the method 200 may include restricting, by the broker application, execution of the trade order when the client response includes a rejection.

At 218, the method 200 may include sending, by the broker application, the trade order to an execution venue for execution when the client response includes an acceptance. According to certain embodiments, the method 200 may include sending, by the broker application and to the client device 112, a confirmation notice that reflects a successful execution of the trade order when the trade order is executed.

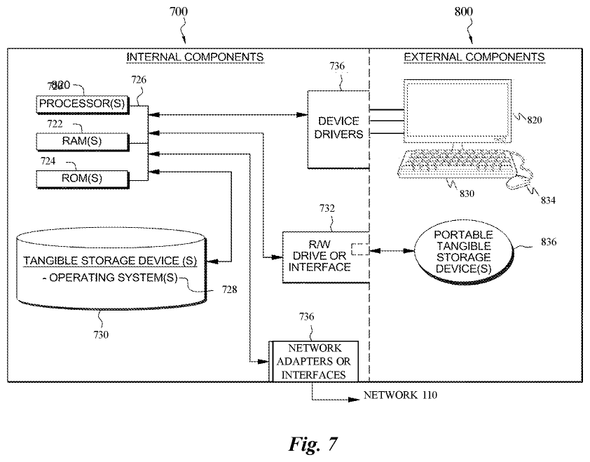

FIG. 7 depicts a block diagram of components of the broker device 112, the client device 111, and/or the server 115, in accordance with certain embodiments. Data processing system 700, 800 is representative of any electronic device capable of executing machine-readable program instructions. Data processing system 700, 800 may be representative of a smart phone, a computer system, PDA, or other electronic devices. Examples of computing systems, environments, and/or configurations that may represented by data processing system 700, 800 include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

The broker device 112, the client device 111, and/or the server 115 may include respective sets of internal components 700 and external components 800 as illustrated in FIG. 7. Each of the sets of internal components 700 includes one or more processors 720, one or more computer-readable RAMs 722 and one or more computer-readable ROMs 724 on one or more buses 726, and one or more operating systems 728 and one or more computer-readable tangible storage devices 730. One or more of the application 121, the application 122, the data files 141, and/or the data files 142 are stored on one or more of the respective computer-readable tangible storage devices 730 for execution by one or more of processors 720 via one or more of the respective RAMs 722 (which typically include cache memory). In the embodiment illustrated in FIG. 7, each of the computer-readable tangible storage devices 730 is a magnetic disk storage device of an internal hard drive. Alternatively, each of the computer-readable tangible storage devices 730 is a semiconductor storage device, such as ROM 724, EPROM, flash memory or any other computer-readable tangible storage device that can store a computer program and digital information.

Internal components 700 also include a R/W drive or interface 732 to read from and write to one or more portable computer-readable tangible storage devices 836, such as a CD-ROM, DVD, memory stick, magnetic tape, magnetic disk, optical disk, or semiconductor storage device. The application 121, the application 122, data files 141, and/or the data files 142 can be stored on one or more of the respective portable computer-readable tangible storage devices 836, read via the respective R/W drive or interface 732 and loaded into the respective computer-readable tangible storage devices 730.

Each set of internal components 700 also includes network adapters or interfaces 736 such as a TCP/IP adapter cards, wireless Wi-Fi interface cards, or 3G or 4G wireless interface cards or other wired or wireless communication links. The application 121, the application 122, data files 141, and/or the data files 142 can be downloaded to their respective computing devices, respectively, from an external computer via a network (for example, the Internet, a local area network or other, wide area network) and respective network adapters or interfaces 736. From the network adapters or interfaces 736, the application 121, the application 122, data files 141, and/or the data files 142 are loaded into the respective computer-readable tangible storage devices 730. The network may comprise copper wires, optical fibers, wireless transmission, routers, firewalls, switches, gateway computers and/or edge servers.

Each of the sets of external components 800 can include a computer display monitor 820, a keyboard 830, and a computer mouse 834. External components 800 can also include touch screens, virtual keyboards, touch pads, pointing devices, and other human interface devices. Internal components 700 also include device drivers 736 to interface to computer display monitor 820, keyboard 830 and computer mouse 834. The device drivers 736, R/W drive or interface 732 and network adapters or interfaces 736 comprise hardware and software (stored in storage device 730 and/or ROM 724).

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

Based on the foregoing, a computer system and method and program product have been disclosed in accordance with the embodiments. However, numerous modifications and substitutions can be made without deviating from the scope of the present invention. Therefore, the instant disclosure has been disclosed by way of example and not limitation.

What is claimed is:

1. A method for pushing trade recommendations to a client device, the method comprising:
receiving, at a broker device, input associated with a trade recommendation to be reviewed by the client, the broker device executing an instance of a broker application, wherein the input comprises due diligence data associated with the trade recommendation and is associated with a unique resource locator (URL), the URL is stored by the broker device and enables retrieval of the input;
generating, by the broker application, a trade order using the input, the trade order is associated a security;
sending, by the broker application, the trade order to a client device for client approval, the client device associated with the client, the URL included in the trade order and accessible by the client;
generating, by the client device, a client response to the trade order, the trade order displayed on an output device associated with the client device, wherein the client response conveys an acceptance or a rejection of the trade order;
sending, by the client device, the client response to the broker device;
receiving, at the broker application, the client response;
storing, by the broker application, the client response in a storage location and restricting modification to the client response, the storage location associated with the URL;
restricting, by the broker application, execution of the trade order when the client response comprises the rejection;
sending, by the broker application, the trade order to an execution venue for execution when the client response comprises the acceptance.

2. The method of claim 1, wherein
sending the trade order to the client device for client approval comprises:
encrypting, by the broker application, the trade order to form a first encrypted trade order; and
sending, by the broker application, the encrypted trade order to the client device for client approval.

3. The method of claim 2, wherein
generating the client response to the trade order comprises:
receiving, at the client device, the first encrypted trade order, the client device executing an instance of a client application;
decrypting, via the client application, the first encrypted trade order to generate a first decrypted trade order;
displaying, by the client application, the first decrypted trade order on the output device;
receiving, by the client application, a client selection input generated by an input device associated with the client device to generate a reviewed trade order.

4. The method of claim 3, wherein
sending the client response to the broker device comprises:
encrypting, by the client application, the reviewed trade order to generate a second encrypted trade order; and
sending, by the client application, the second encrypted trade order to the broker application.

5. The method of claim 4, wherein
the input comprises one or more of:
text;
an image;
a research analysis in support of the trade order, the research analysis associated with a broker, the broker associated with the broker device;
a total number of shares allowed for the trade order;
a price limit reflecting a maximum purchase price allowed for each of the shares; and
a transaction time period reflecting a time frame that the trade order is executable within.

6. The method of claim 5, wherein
the input device comprises one or more of:
a mouse;
a touch screen;
a keyboard;
a joystick;
a camera;
a biometric scanner;
the output device comprises one or more of:
a display;
a touch screen;
a speaker;
a printer; and
an optical mark reader.

7. The method of claim 6, wherein
decrypting the encrypted trade order comprises:
receiving, by the client application, authentication data generated by the input device;
determining, by the client application, whether the authentication data is associated with the client;
decrypting, by the client application, the first encrypted trade order to generate the first decrypted trade order when it is determined that the authentication data is associated with the client; and
restricting, by the client application, access to the first encrypted trade by the client when it is not determined that the authentication data is associated with the client.

8. A system comprising:
one or more servers comprising:
one or more first processors; and
one or more first non-transitory computer-readable media bring first instructions executable or more first processors, wherein the first instructions program the one or more first processors to:
receive, at a broker device, input associated with a trade recommendation to be reviewed by the client, the broker device executing an instance of a broker application, wherein the input comprises due diligence data associated with the trade recommendation and is associated with a unique resource locator (URL), the URL is stored by the broker device and enables retrieval of the input;
generate, by the broker application, a trade order using the input, the trade order is associated a security;
send, by the broker application, the trade order to a client device for client approval, the client device associated with the client, the URL included in the trade order and accessible by the client;
generate, by the client device, a client response to the trade order, the trade order displayed on an output device associated with the client device, wherein the client response conveys an acceptance or a rejection of the trade order, the acceptance conveying;
send, by the client device, the client response to the broker device;
receive, at the broker application, the client response;
store, by the broker application, the client response in a storage location and restricting modification to the client response, the storage location associated with the URL;
restrict, by the broker application, execution of the trade order when the client response comprises the rejection; and
send, by the broker application, the trade order to the execution venue for execution when the client response comprises the acceptance.

9. The system of claim 8, wherein in sending the trade order to the client device for client approval, the first instructions program the one or more first processors to:
encrypt, by the broker application, the trade order to form a first encrypted trade order; and
send, by the broker application, the encrypted trade order to the client device for client approval.

10. The system of claim 9, wherein in generating the client response to the trade order, the first instructions program the one or more first processors to:
receive, at the client device, the first encrypted trade order, the client device executing an instance of a client application;
decrypt, via the client application, the first encrypted trade order to generate a first decrypted trade order;
display, by the client application, the first decrypted trade order on the output device;
receive, by the client application, a client selection input generated by an input device associated with the client device to generate a reviewed trade order.

11. The system of claim 10, wherein in sending the client response to the broker device the first instructions program the one or more first processors to:
encrypt, by the client application, the reviewed trade order to generate a second encrypted trade order; and
send, by the client application, the second encrypted trade order to the broker application.

12. The system of claim 11, wherein
the input comprises one or more of:
text;
an image;
a research analysis in support of the trade order, the research analysis associated with a broker, the broker associated with the broker device;
a total number of shares allowed for the trade order;
a price limit reflecting a maximum purchase price allowed for each of the shares; and
a transaction time period reflecting a time frame that the trade order is executable within.

13. The system of claim 12, wherein
the input device comprises one or more of:
a mouse;
a touch screen;
a keyboard;
a joystick;
a camera;
a biometric scanner;
the output device comprises one or more of:
a display;
a touch screen;
a speaker;
a printer; and
an optical mark reader.

14. The system of claim 9, wherein in decrypting the encrypted trade order, the first instructions program the one or more first processors to:
receive, by the client application, authentication data generated by the input device;
determine, by the client application, whether the authentication data is associated with the client;
decrypt, by the client application, the first encrypted trade order to generate the first decrypted trade order when it is determined that the authentication data is associated with the client; and
restrict, by the client application, access to the first encrypted trade by the client when it is not determined that the authentication data is associated with the client.
